(19) United States
(12) Patent Application Publication
(10) Pub. No.: US 2015/0307394 A1
(43) Pub. Date: Oct. 29, 2015

(54) METHOD FOR THE PRODUCTION OF THIN SHEET GLASS

(71) Applicants: SAINT-GOBAIN GLASS FRANCE, Courbevoie (FR); SAINT-GOBAIN ADFORS, Chambery (FR)

(72) Inventors: Rene GY, Bondy (FR); Mathieu JOANICOT, Chatenay Malabry (FR); Anne CHOULET, Levallois (FR)

(73) Assignees: SAINT-GOBAIN GLASS FRANCE, Courbevoie (FR); SAINT-GOBAIN ADFORS, Chambery (FR)

(21) Appl. No.: 14/438,926

(22) PCT Filed: Oct. 28, 2013
(86) PCT No.: PCT/FR2013/052571

§ 371 Date: Apr. 28, 2015

(30) Foreign Application Priority Data
Oct. 29, 2012 (FR) 12 60293

(51) Int. Cl. C03C 25/10; C03C 25/42

(52) U.S. Cl. CPC C03C 25/1095; C03C 25/42

(57) ABSTRACT

The invention relates to a process for manufacturing flat glass, comprising:
(a) impregnating a glass textile with a molten glass composition, the glass forming the fibers of the glass textile having a softening temperature above that of the glass forming the molten glass composition, said step (a) comprising
(a1) impregnating the glass textile with a glass frit composition, and
(a2) heating the impregnated glass textile obtained in step (a1) to a temperature above the softening temperature of the glass frit; and
(b) cooling the impregnated glass textile obtained in step (a) so as to obtain a glass sheet,
   and to a glass sheet manufactured using such a process.

The present invention relates to a novel process for manufacturing flat glass, in particular thin glass sheets comprising a glass textile incorporated in a glass matrix.

Many glass manufacturers have for a few years produced what is referred to in English as ultra-thin glass (“verre pelliculaire” or “verre ultramince” in French) having a thickness comprised between a few tens of microns and about 200 μm. This glass, manufactured by float or fusion draw process, is available in large sheets or in the form of continuous strips. The thinnest ultra-thin glass is flexible and may be rolled up. This flexibility allows it to be used in industrial processes conventionally reserved for films and sheets made of plastic, in particular roll-to-roll processing.

The fusion draw process results in thin, transparent glass that is characterized by its exceptional surface smoothness, particularly important in high-technology applications such as LCD screens. However, the fusion draw process is complex, unproductive and difficult to control, and the high cost of the glass it produces is prohibitive for many applications.

The present invention provides a replacement product for known thin and ultra-thin glass, and a manufacturing process that is considerably simpler than the fusion draw process.

Most of the thin glasses of the present invention have an optical quality (transparency) lower than that of known thin glass. However, their surface quality is satisfactory, even equivalent to that of known ultra-thin glass. They are fabricated from cheap raw materials (glass textiles and glass frits) available in large amounts and in various qualities.

The basic idea behind the present invention is to take advantage of the similarity between glass textiles and ultra-thin glass. Specifically, these two types of products have a similar chemical composition, geometry, and mechanical behavior, and mainly differ in their permeability to fluids and their transparency.

The process of the present invention decreases and even removes the permeability of glass textiles to fluids, and increases their transparency to light, thus making them more like thin and ultra-thin glass.

To achieve this objective, a glass textile has its apertures filled, its scattering interfaces reduced in number, and its surface smoothed by incorporating it into a glass matrix resulting, for example, from melting a glass frit applied to the textile. The glass textile is not completely melted, thereby guaranteeing that the assembly retains sufficient mechanical strength during the heating step, thus allowing a uniform tensile force to be applied and a good planarity to be obtained.

The process of the present invention is characterized by a very high process flexibility. Specifically, both the glass textile and the glass matrix may be independently chosen from a very large number of products available on the market, the only constraint being that the frit must have a softening temperature below that of the glass textile. The process of the present invention may be implemented with tools that require relatively few large investments, which represents a considerable advantage over float and fusion draw processes.

Thus, one subject of the present invention is a process for manufacturing flat glass, comprising:

(a) impregnating a glass textile with a molten glass composition, the glass forming the fibers of the glass textile having a softening temperature above that of the glass forming the molten glass composition, said step (a) comprising

(a1) impregnating the glass textile with a glass frit composition, and

(a2) heating the impregnated glass textile obtained in step (a1) to a temperature above the softening temperature of the glass frit; and

(b) cooling the impregnated glass textile obtained in step (a) so as to obtain a glass sheet.

In the present application the expression “softening temperature” denotes what is called the Littleton temperature, also called the Littleton point, determined according to standard ASTM C338. This is the temperature at which the viscosity of a glass fiber measured according to this method is equal to 1×10^{6.6} Pa.s.

The expression “molten glass composition” is, in the present application, understood to mean a fluid glass composition heated to a temperature above its Littleton softening point.

At the moment when the glass textile is impregnated with the molten glass composition, the latter is preferably heated to a temperature above, by at least 100° C. and preferably by at least 200° C., its Littleton softening point.

In step (a) of the process of the invention the glass textile is coated with a glass frit composition, generally at room temperature, and the frit is melted only later on.

Step (a) therefore comprises two steps in succession, namely:
a first step (a1) of impregnating the glass textile with a glass frit composition; and
a second step (a2) of heating the impregnated glass textile obtained in step (a1) to a temperature above the softening temperature of the glass frit.

Implementing step (a) in this way enables perfect control of the amount of glass applied.

The glass frit composition may be applied (step (a1)) using various known techniques such as screen printing, coating by means of a threaded rod or a doctor blade, roll coating, or slot coating.

Although the products obtained by the process of the present invention are “flat” products in the sense that overall they preserve the geometry of the textile, which is characterized by two main surfaces that lie parallel to each other, the process of the present invention is in no way limited to perfectly flat products. Specifically, initial trials carried out by the Applicant resulted in materials that were very satisfying from an aesthetic point of view, and it would be entirely envisageable to use them to manufacture decorative objects of various shapes, such as lampshades, tubes, corrugated walls, etc.

With regard to more technical applications, the products obtained by the process of the present invention however preferably have a both flat and planar shape. To obtain a final product with satisfactory planarity, it is essential to stretch the glass textile at least during the cooling step, and preferably throughout the process.

In a preferred embodiment, the glass textile is therefore subjected to a tensile force in at least one direction in the plane of the glass textile, throughout step (a), and this tensile force is preferably maintained during step (b), at least until the product obtained has stiffened.

Placing the glass textile under tension during the melting/glass-application step and the cooling step is perfectly compatible with and even necessary for implementation of a continuous process, which is a preferred embodiment of the present invention.

In such a continual process, the glass textile is a continuous strip and steps (a) and (b) are continuous steps implemented upstream and downstream in the processing line, the direction of the tensile force being parallel to the run direction of the continuous strip of glass textile.

The glass textile may be a nonwoven or even a woven. When it is a woven, the number of warp threads and/or the number of weft threads is typically comprised between 3 and 100 per cm, and preferably between 10 and 80 per cm.

The objective of the present invention is to fill all the holes in the glass textile. To achieve this aim, it is indispensable to ensure that the apertures of the starting textile are not too large. Glass woven or nonwoven textiles with apertures having an average equivalent diameter smaller than 1 mm, and preferably smaller than 0.1 mm, will therefore preferably be chosen.

The weight per unit area of the glass textiles used is generally comprised between 50 and 500 g/m², preferably between 80 and 400 g/m², and in particular between 100 and 200 g/m².

The amount of glass applied in the form of the glass frit composition is comprised in the interval ranging from 100 to 2000 g/m², and preferably from 200 to 1500 g/m².

This amount of glass may of course be applied in one go, i.e. in a single layer.

However, in certain cases it may be advantageous to create, in the glass layer of the finished product, a gradient in certain properties such as refractive index, thermal expansion constant, scattering particle density, etc. In this case, all that is required is to apply, in succession, during step (a1), a plurality of layers of glass frit composition having the properties in question, and to melt them together in step (a2).

The glass frit composition generally contains 50 to 90% by weight, and preferably 70 to 85% by weight of a glass powder, and from 10 to 50% by weight, and preferably 15 to 30% by weight of a binder, or medium, formed from an organic polymer dissolved in a solvent.

The heating step (step (a2)) then preferably comprises a plurality of temperature plateaus, the first plateau (100° C.-200° C.) serving to evaporate the solvent, the second plateau (350-450° C.) to remove the organic polymer, and the third plateau (above 550° C.) to melt the glass frit. Each temperature plateau is preferably maintained for a length of time comprised between about 10 minutes and 1 hour, and in particular between 15 and 30 minutes.

However, it may also be envisioned to replace this stepped heating step with a flash heating step involving increasing the temperature of the textile by at least 600° C. in a few seconds. Such flash heating is particularly advantageous in the context of a continuous industrial process, and may, for example, be achieved using a laser beam, a bank of plasma torches, a bank of burners, or using (resistive, inductive, or microwave) heating elements.

After the glass frit has completely melted, the glass textile impregnated with molten glass is cooled (step (b)). This cooling may be carried out passively or in a controlled way, the impregnated textile being kept in a hot environment for example. In order to ensure a good temperature uniformity throughout the cooling step, it may also be useful to heat certain zones liable to cool more rapidly than others.

The hot glass textile obtained in step (a) preferably does not make contact with any solids or liquids before it has cooled to a temperature below, by at least 50° C. and preferably by at least 100° C., the softening temperature of the glass forming the molten glass composition.

The first samples prepared by the Applicant have proved to be highly diffusive. This high diffusiveness has been attributed, on the one hand, to the large difference between the refractive index of the glass forming the textile and that of the glass forming the glass frit or glass bath. When it is desired to obtain a high diffusiveness, for example in the field of OLED substrates, care will be taken to ensure that the refractive index of the glass forming the glass frit or glass bath is higher, by at least 0.01 and preferably by at least 0.05, than the refractive index of the glass textile.

In contrast, when it is desired to increase, as much as possible, the transparency of the final products, the refractive index of the glass forming the glass frit or glass bath will need to be substantially identical to that of the glass forming the glass textile.

Microscopy of cross sections of the products showed that the high diffusiveness is also due, at least in part, to insufficient wetting of the glass fibers by the liquid glass, preventing satisfactory penetration of the matrix into the center of the multi-filament fibers. The Applicant believes that it will be possible to alleviate, even overcome, this problem by reducing the viscosity of the liquid glass and/or by increasing the time for which the liquid glass is kept at high temperature.

To the knowledge of the Applicant, at the present time no description of a flat product obtained by combining a glass textile and a molten glass composition exists. Such a flat product, or glass sheet, capable of being manufactured by a process such as described above, is therefore another subject of the present invention.

This glass sheet preferably has a thickness comprised between 50 μm and 1000 μm, and in particular between 100 μm and 800 μm.

In this glass sheet, the structure of the glass textile may, due to its transparency, be visible to the naked eye. This structure may also be masked by a highly diffusive glass film, or it may even no longer be visible due to the disappearance of the interfaces between the textile material and the enamel coating the latter.

### EXAMPLE

Two woven glass textiles respectively having a weight per unit area of 165 g/m² (A) and 117 g/m² (B) were printed by screen printing with one, two or three layers of a glass frit composition (about 80% by weight of a glass powder in 20% of a medium containing terpineol, acetic acid and ethylcellulose).

The table below gives the number of screen-printed layers, the weight per unit area of the impregnated textile, the weight per unit area of the glass fabric alone, the cumulative weight per unit area of the printed layers, and the estimated thickness of the glass film formed after melting the frit composition (weight per-unit volume=2.5).

Each indicated value is the average calculated from two samples.

| | | Weight per | Weight per | Weight per | Estimated | |
|---|---|---|---|---|---|---|
| | | unit area of | unit area of | unit area of | thickness of | Presence |
| | Number | the impregnated | the fabric | the deposited | the enamel | of holes |
| | of | fabric | alone | glass layer | layer formed | after |
| Textile | layers | (g/m²) | (g/m²) | (g/m²) | (μm) | melting |
| A | 1 | 600 | 165 | 435 | 174 | Yes |
| | 2 | 817 | 165 | 652 | 260 | No |
| | 3 | 1006 | 165 | 841 | 336 | No |
| B | 1 | 593 | 117 | 476 | 190 | Yes |
| | 2 | 793 | 117 | 676 | 270 | No |
| | 3 | 905 | 117 | 788 | 320 | No |

The fabrics thus impregnated were subjected to gradual heating with three plateaus:
temperature increase of 5° C./minute from 25-150° C.;
temperature held at 150° C. for 20 minutes;
temperature increase of 5° C./minute from 150-430° C.;
temperature held at 430° C. for 20 minutes;
temperature increase of 5° C./minute from 430-570° C.; and
temperature held at 570° C. for 20 minutes.

It was observed that starting from two frit layers all the holes of the textile were filled. The final products were overall quite fragile. Those products that received two or three frit layers could however be handled without too much difficulty. All of the products had a highly diffusive aspect, or were even almost opaque.

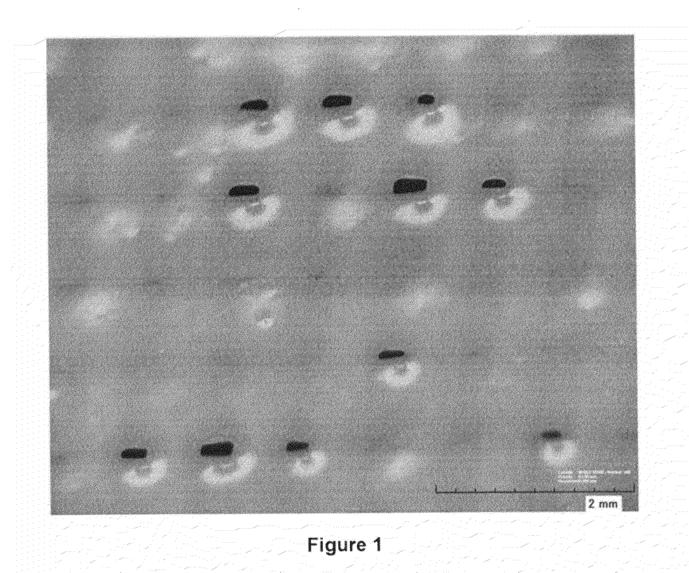

FIG. 1 is a micrograph of a B-group textile obtained after one single frit layer had been printed and melted. Certain holes in the textile, which are visible due to their transparency, have not been filled.

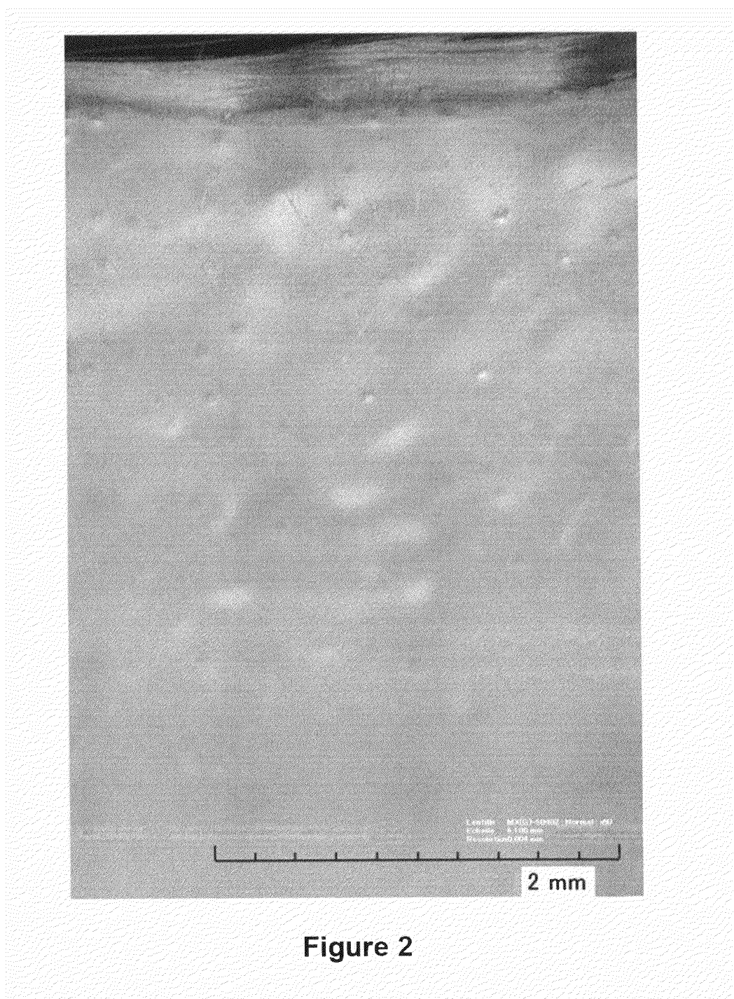

FIG. 2 is a photograph of an A-group textile taken after two frit layers had been printed and melted. Holes are no longer visible. The enamel has a highly diffusive character. Small bubbles that rose to the surface of the enamel may be seen.

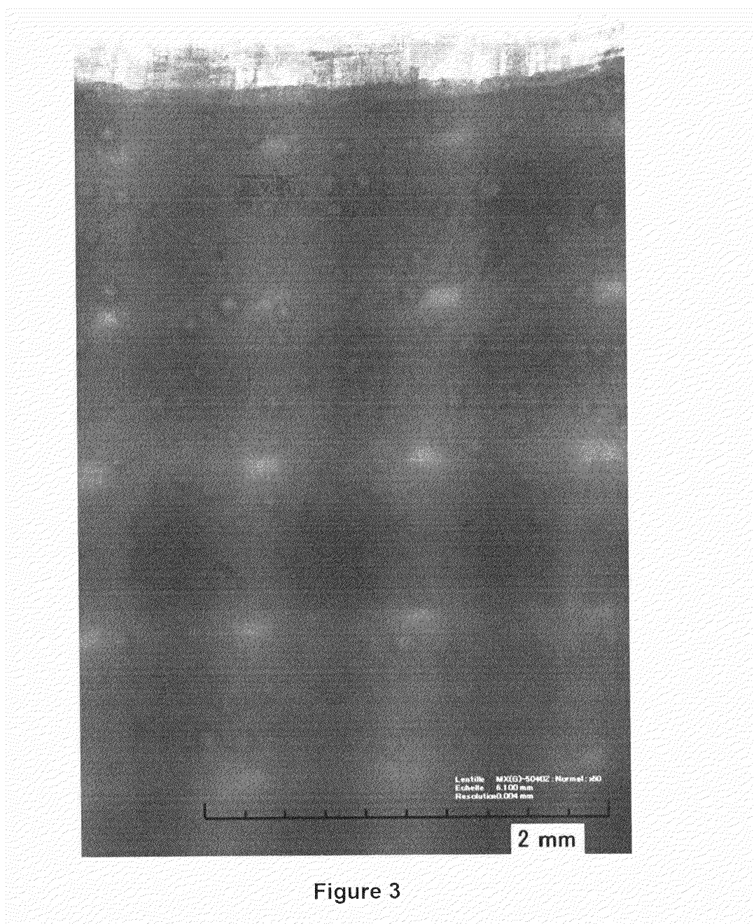

FIG. 3 shows a photograph of the same sample as that in FIG. 2, illuminated from behind. This view in transmission confirms the presence of many gas bubbles.

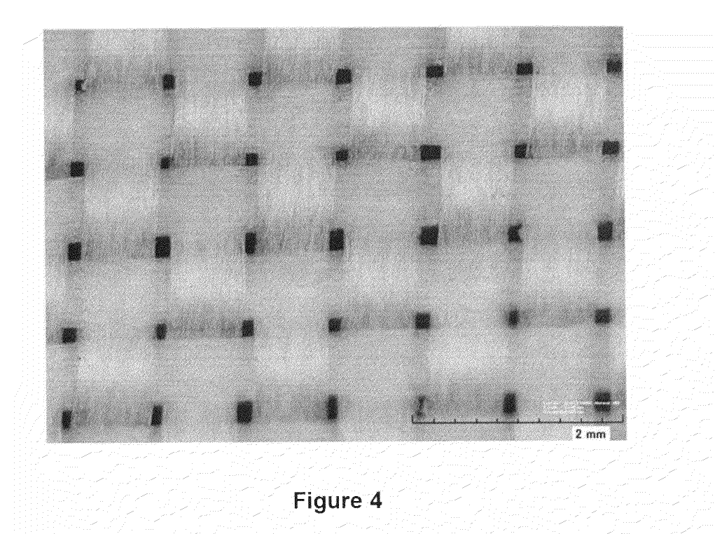

FIG. 4 is a photograph of the textile A without any enamel deposit.

1. A process for manufacturing flat glass, the process comprising:
(a) impregnating a glass textile with a molten glass composition, the glass forming fibers of the glass textile having a softening temperature above that of the glass forming the molten glass composition, said step (a) comprising
(a1) impregnating the glass textile with a glass frit composition, and
(a2) heating the impregnated glass textile obtained in step (al) to a temperature above a softening temperature of the glass frit; and
(b) cooling the impregnated glass textile obtained in step (a) so as to obtain a glass sheet.

2. The process of claim 1, wherein the softening temperature of the glass forming the fibers of the glass textile is above, by at least 100° C., that of the glass forming the molten glass composition.

3. The process of claim 1, wherein step (a1) occurs by screen printing, coating with a threaded rod or a doctor blade, roll coating or slot coating.

4. The process of claim 1, wherein the glass textile is subjected to a tensile force in at least one direction in a plane of the glass textile, throughout step (a), such that the tensile force is maintained during step (b) at least until a product obtained has stiffened.

5. The process of claim 1, wherein the glass textile has a weight per unit area of between 50 and 500 g/m².

6. The process of claim 1, wherein an amount of glass applied in step (a1) in the form of the glass frit composition ranges from 100 to 2000 g/m².

7. The process of claim 1, wherein an average equivalent diameter of apertures of the glass textile is smaller than 1 mm.

8. The process of claim 1, wherein the glass textile is a woven having a number of warp threads, a number of weft threads, or both, of between 3 and 100/cm.

9. The process of claim 1, wherein the glass textile is a nonwoven.

10. The process of claim 1, wherein a hot glass textile obtained in step (a) does not make contact with any solids or liquids before cooling to a temperature below, by at least 50° C., the softening temperature of the glass forming the molten glass composition.

11. The process of claim 1, wherein a refractive index of the glass forming the glass frit or the glass bath is substantially identical to that of the glass forming the glass textile.

12. The process of claim 1, wherein refractive index of the glass forming the glass frit or the glass bath is higher, by at least 0.01, than a refractive index of the glass textile.

13. A glass sheet obtained by the process of claim 1.

14. The glass sheet of claim 13, having a thickness between 50 μm and 1000 μm.

15. The glass sheet of claim 13, wherein structure of the glass textile is, due to its transparency, visible to the naked eye.

16. The process of claim 1, wherein the softening temperature of the glass forming the fibers of the glass textile is above, by at least 200° C., that of the glass forming the molten glass composition.

17. The process of claim 1, wherein the glass textile has a weight per unit area of between 80 and 400 g/m².

18. The process of claim 1, wherein an amount of glass applied in step (al) in the form of the glass frit composition ranges from 200 to 1500 g/m².

19. The process of claim 1, wherein an average equivalent diameter of apertures of the glass textile is smaller than 0.1 mm.

20. The process of claim 1, wherein the glass textile is a woven having a number of warp threads, a number of weft threads, or both, of between 10 and 80/cm.
